(19) United States
(12) Patent Application Publication
(10) Pub. No.: US 2007/0090704 A1
(43) Pub. Date: Apr. 26, 2007

(54) Outer-rotor-driving pump having annular ferrite magnet with grain alignment on its inner periphery

(75) Inventor: Chi-Wen Chen, Taipei City (TW)

Correspondence Address: BACON & THOMAS, PLLC, 625 SLATERS LANE, FOURTH FLOOR, ALEXANDRIA, VA, 22314, US

(73) Assignee: SUPER ELECTRONICS CO., LTD, Taipei City (TW)

(21) Appl. No.: 11/476,859

(22) Filed: Jun. 29, 2006

(30) Foreign Application Priority Data
Oct. 21, 2005 (TW) 094218278

(51) Int. Cl. H02K 5/12; H02K 21/12; F04B 17/00

(52) U.S. Cl. 310/86; 310/156.26; 310/87; 417/423.11; 417/423.7

(57) ABSTRACT

A pump driven by an outer rotor and having an annular ferrite magnet with grain alignment on its inner periphery comprising a housing, a wheel blade, a stator and an outer rotor surrounding the stator, wherein the pump uses the wheel blade to draw and deliver fluid in the water sucking area. The pump is characterized in that: the rotor includes a rotating disk and the annular ferrite magnet fixed on the inner periphery of the disk, the magnet is a multipolar anisotropic permanent magnet, the main body of the magnet is divided into a magnetic conductive outer layer and a magnetic inner layer, in order that fluxes of the magnetic inner layer turn back right away when they pass the outer layer to thereby shorten magnetic loops, to increase magnetic force and the effect of magnetic energy accumulation, and to increase the efficiency of the pump rotated by the rotor.

### BACKGROUND OF THE INVENTION

1. Field of the Invention

The present invention relates to a pump driven by an outer rotor, and especially to a pump driven by an outer rotor and having an annular ferrite magnet with grain alignment on its inner periphery in order to increase magnetic force and the effect of magnetic energy accumulation, and further to increase the efficiency of the pump.

2. Description of the Prior Art

The scope of application of pumps is very wide, places where water or other fluid is needed to obtain through pumping all require pumps, for example, pumps sunk in water for breeding living things, oil pressure pumps on processing machines, pumps used in cars and computers for heat sinking with water and waste water pumps etc.

Among various pumps for different usages, a pump driven by an outer rotor made by using the principle of a DC brush-free motor takes advantage of the magnetic coupling mode in transmitting and thereby does not need a lining for water proofing, hence it has the excellent features of completely no water leakage, long life of use, needing no maintenance and preparing, no water in the pump and no damage even when there are impurities in the water; therefore, it will gradually take the place of conventional pumps made by using the principle of induction motor in application.

E.g., for the pumps used for computers to be heat sunk by water cooling (heat sinking of a CPU of a computer had developed from a fin type radiator to a heat pipe radiator which has gradually been unable to effectively do heat sinking; thereby recently, computer manufacturers have taken water cooling radiator as one of their standard equipment), by virtue that a pump must be mounted in or around the mainframe of a computer, once it has leakage of water, an extreme damage can be created; hence a pump driven by an outer rotor having no worry of water leakage is needed.

And for instance, an environmental conservative waste water recovering pump used for a car washer has large amount of dust, sand and chemical material (mist wax) contained in the recovered waste water, the pump made according to the principle of a conventional induction motor is subjected to damage by the impurities in the water; while using a pump driven by an outer rotor can largely increase the life of use of the pump. Evidently, a pump driven by an outer rotor will take the leadership in the industry of the art.

However, an outer rotor magnet used presently in a pump driven by the outer rotor mostly uses the neodymium iron boron (NdFeB) series; such material is made by mixing 94% neodymium iron boron (NdFeB) and 6% nylon, it is formed an annular member by injection molding, the inner periphery of the annular member are magnetized to form a multipolar anisotropic annular magnet. The magnetic characteristics of such material surely can satisfy requirements, but it has a defect in having high cost (neodymium is rare metal with smaller yield of production) and is difficult to be produced, hence an article made of it is quite expensive.

Therefore, manufacturers use magnets made of/by ferrite magnet material/anisotropic/wet punching shaping mode in lieu of the neodymium iron boron (NdFeB) magnets to lower their costs. By the problem resided in technical processing of such outer rotor magnets, such magnets can only be used to make lunar anisotropic ferrite magnets and then at least three of such lunar magnets are assembled to form an annular shape. These annular permanent magnets assembled from the lunar anisotropic ferrite magnets have the following grave defects in their functions:
1. In assembling, an air gap will be formed between every two magnets to be subjected to inducing magnetic leakage; hence cogging will be induced during running of the annular permanent magnets.
2. By virtue that the annular permanent magnets are each formed from several lunar magnets, their work of processing and assembling is more time consumptive, and their inner roundness is inferior.
3. the surface magnetic flux density of the magnets formed of neodymium iron boron (NdFeB) by injection molding is 2100˜2300 Gauss, while that of the magnets made from ferrite magnets is only 1650˜1950 Gauss which is slight insufficient.
4. The sintering temperature of the ferrite magnets is about 1240° C., the thickness of the sintered magnets shall not be too small, otherwise the magnets is fragile, so that the outer diameter of each assembled annular magnet is larger; this makes a bulky housing of a whole pump.
5. By virtue of the problems of magnetic leakage, cogging, insufficiency of magnetic force and larger outer diameter etc., each permanent annular magnet assembled from lunar anisotropic ferrite magnets is unable yet to get the acknowledgement of meeting the specification; it is less competitive as for an added value to a commodity.

And more, when the composite material of neodymium iron boron (NdFeB) or a lunar anisotropic ferrite magnet is used on a pump rotated by an outer rotor, its magnetic fluxes all pass through an iron rotating disk surrounding the annular magnet and through air, then form magnetic loops with an inner stator, in this mode, loss of magnetic fluxes is very much, thus the effect of the pump is reduced.

In fact, using an annular magnet assembled from lunar anisotropic permanent ferrite magnets is not bad in addition to its prevalence in price; its physical characteristics are better than those of the magnets formed of the neodymium iron boron (NdFeB) series; it still is the excellent option of material to those industries having higher requirement for the range of temperature, humidity durability and alkali resistance. Besides, the material of a ferrite magnet is produced mainly of the recovered mill scale material obtained from acid washing of steel plates; it more meets the tendency of environmental conservation.

And more, as stated above, speaking only of the magnetic characteristics, the material of a ferrite magnet is inferior than the neodymium iron boron (NdFeB) series. Therefore, if the structure of the annular ferrite magnet is improved and is used as a magnet of an outer rotor provided on a pump rotated by the outer rotor, magnetic leakage can be reduced, surface magnetic flux density of the magnet and magnetic field intensity can be increased, meantime the work of processing in assembling can be reduced; thereby the magnetic characteristics of the ferrite magnet can be extremely developed, the ferrite magnet will be able to take the place of the magnet of the neodymium iron boron (NdFeB) series which has smaller yield of production and are expensive; this will bring a revolutional influence on the pump driven by the outer rotor to push forward the industry of the art; and this is the ground of studying and developing the structure of the present invention.

### SUMMARY OF THE INVENTION

Particularly, the pump rotated by an outer rotor and having an annular ferrite magnet with grain alignment on its inner periphery of the present invention has a housing, a wheel blade, a stator and an outer rotor surrounding the stator, wherein the wheel blade is provided in a water sucking area of the housing to be rotated synchronically with the outer rotor, when electric power enters the stator to make the magnetic poles change alternately, the outer rotor is driven by the function of magnetic coupling to synchronically rotate the wheel blade, wherein the present invention takes advantage of the wheel blade to draw and deliver fluid in the water sucking area. The present invention is characterized in that: the outer rotor is composed of a rotating disk and an annular ferrite magnet with grain alignment on its inner periphery and being fixed on the inner periphery of the rotating disk, the annular ferrite magnet with grain alignment on its inner periphery is a multipolar anisotropic permanent magnet, the main body of the annular ferrite magnet is divided into a magnetic conductive outer layer which is not magnetic and a magnetic inner layer, in order that magnetic fluxes of the magnetic inner layer turn back right away when they pass the magnetic conductive outer layer to thereby shorten the magnetic loops, and to increase magnetic force and the effect of magnetic energy accumulation, and further to increase the efficiency of the pump rotated by the outer rotor.

The object of dividing the annular ferrite magnet with grain alignment on its inner periphery into the magnetic inner layer and the magnetic conductive outer layer as stated above is to make magnetic fluxes of the magnetic inner layer turn back right away when they pass the magnetic conductive outer layer to thereby shorten the magnetic loops, and to increase magnetic force and the effect of magnetic energy accumulation, and further to increase the efficiency of the pump rotated by the outer rotor. Not like the mode of the conventional compound material of the neodymium iron boron (NdFeB) magnets or the lunar anisotropic ferrite magnets, wherein when in use of the pump rotated by the outer rotor, the magnetic fluxes all pass through an iron rotating disk surrounding the annular magnet and through air, then form magnetic loops with the inner stator, in this mode, loss of magnetic fluxes is very much, thus the effect of the pump is reduced.

In addition to these, the present invention transmits in the magnetic coupling mode, thereby it needs no lining for water proofing, hence it has the advantages of completely no water leakage, long life of use, needing no maintenance, preparing, no water in the pump and no damage even when there are impurities in the water.

In practicing the present invention, the outer rotor has two embodiments in application mode to drive the wheel blade as stated below:
1. The rotating disk of the outer rotor and the annular ferrite magnet with grain alignment on its inner periphery are in the water sucking area of the housing, and the wheel blade is provided in the rotating disk, the stator is provided in an isolation area of the housing; when electric power enters the stator to make the magnetic poles change alternately, the outer rotor is driven and the wheel blade is rotated, a function of drawing and delivering fluid in the water sucking area is performed as a pumping action by the wheel blade.
   The outer rotor of the embodiment is placed in the water sucking area for contacting with fluid, by virtue that the annular ferrite magnet is divided into a magnetic conductive outer layer which is not magnetic and a magnetic inner layer, the magnet needs not to have therearound magnetic conductive metal for forming magnetic loops; i.e., the rotating disk does not need to be made of metallic magnetic conductive material (iron), it can thereby integrally injection molded together with the wheel blade of plastic, this not only can lower the cost of assembling, but also will have no problems of rendering easy oxidation of the metallic magnetic conductive material to result rusting and corrosion. And the annular ferrite magnet with grain alignment on its inner periphery has the superior features in the wider range of temperature, humidity durability and alkali resistance; the embodiment can have a broader range of application.
2. In the second embodiment of the present invention, the rotating disk of the outer rotor and the annular ferrite magnet with grain alignment on its inner periphery are on the housing and in the isolation area separated from the water sucking area; a rotating axle at the center of the rotating disk is extended out of the isolation area, the tailing end of it is located in the water sucking area to fix together with the wheel blade. Now to make electric power enter the stator to make the magnetic poles change alternately, the outer rotor is driven and the rotating axle is rotated synchronically therewith; by virtue that the rotating axle is extended out of the isolation area to fix together with the wheel blade, hence by transmitting of the rotating axle, the wheel blade in the water sucking area is rotated synchronically therewith to draw and deliver fluid.
   The principle of this second embodiment is same as that of the first embodiment in using the magnetic coupling mode for transmitting, the difference of it from the first embodiment is: the rotating disk of the outer rotor and the annular ferrite magnet with grain alignment on its inner periphery do not contact with the fluid, and the annular ferrite magnet with grain alignment on its inner periphery is not isolated from the stator, so that the effect of magnetic coupling is better.

The present invention will be apparent from the two preferred embodiments thereof after reading the detailed description of the preferred embodiment thereof in reference to the accompanying drawings.

### BRIEF DESCRIPTION OF THE DRAWINGS

FIG. 1 is a sectional schematic view showing the structure of a first preferred embodiment of a pump rotated by an outer rotor of the present invention;

FIG. 2 is a sectional schematic view showing the structure of a second preferred embodiment of the pump rotated by the outer rotor of the present invention;

FIG. 3 is a perspective view showing magnetic loops of magnetic flux of an annular ferrite magnet with grain alignment on its inner periphery of the present invention;

### DETAILED DESCRIPTION OF THE PREFERRED EMBODIMENT

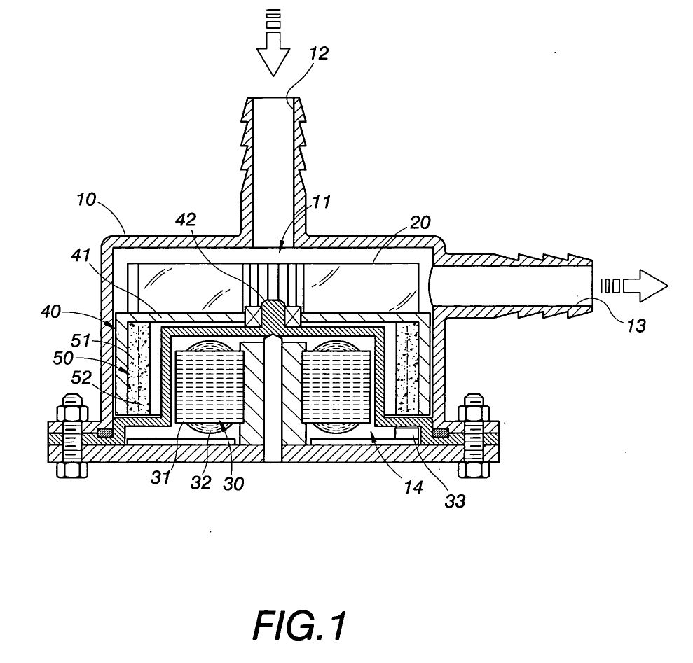

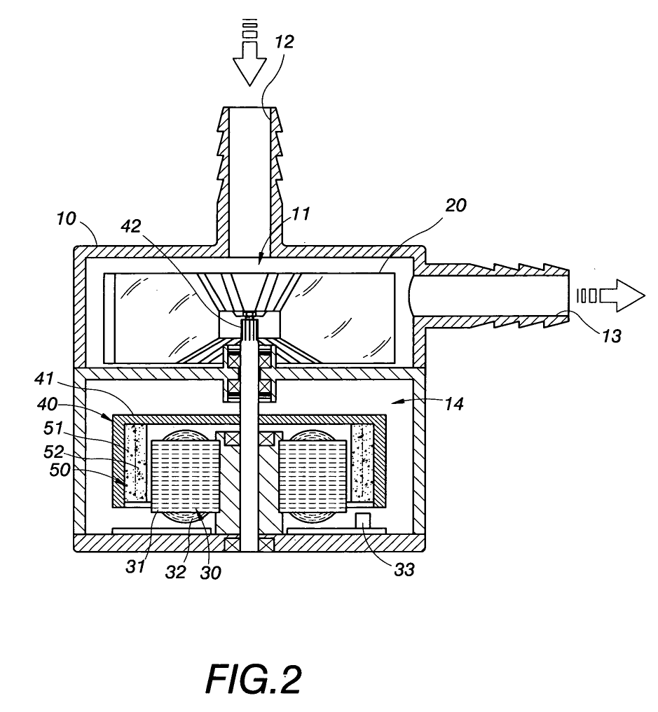

The first and second embodiments of the present invention as shown in FIGS. 1 and 2 each comprises a housing 10, a wheel blade 20, a stator 30 and an outer rotor 40 surrounding the stator 30, wherein the wheel blade 20 is provided in a water sucking area 11 of the housing 10 to be rotated synchronically with the outer rotor 40, when electric power enters the stator 30 to make the magnetic poles change alternately, the outer rotor 40 is driven by the function of magnetic coupling to synchronically rotate the wheel blade 20. Wherein the water sucking area 11 has a water inlet 12 and an water outlet 13; when the wheel blade 20 is rotated in the water sucking area 11, fluid can enter the water sucking area 11 via the water inlet 12, and can be pushed out of the water outlet 13 by rotating of the wheel blade 20, thereby a function of drawing and delivering fluid can be effected.

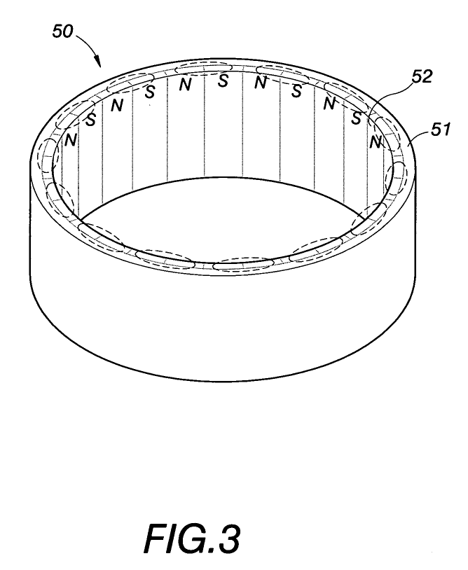

Referring to FIG. 3, the present invention is characterized in that: the outer rotor 40 is composed of a rotating disk 41 and an annular ferrite magnet 50 with grain alignment on its inner periphery and being fixed on the inner periphery of the rotating disk 41, the annular ferrite magnet 50 with grain alignment on its inner periphery is a multipolar anisotropic permanent magnet, the main body of the annular ferrite magnet is divided into a magnetic conductive outer layer 51 which is not magnetic and a magnetic inner layer 52, in order that magnetic fluxes of the magnetic inner layer 52 turn back right away when they pass the magnetic conductive outer layer 51 to thereby shorten the magnetic loops, and to increase magnetic force and the effect of magnetic energy accumulation, and further to increase the efficiency of the pump rotated by the outer rotor 40.

Referring to FIGS. 1 and 2, among the above elements, the stator 30 is composed of a set of yoke 31 and an induction coil 32, thereby electric power is led into the induction coil 32 in an electronic phase changing mode, this can render the stator 30 to create alternate changing of magnetic poles to drive the outer rotor 40 in a magnetic coupling mode. By virtue that the stator 30 does not contact with the fluid, hence the stator 30 shall be isolated from the water sucking area 11; in practicing, the housing 10 can be provided with an isolation area 14 for mounting the stator 30 to be separated from the water sucking area 11. Besides, the stator 30 can be provided further with a Hall element 33 (or a magnetic IC), after sensing the alternate changing of magnetic poles, the Hall element 33 puts out a signal for controlling, in order that the entire pump can operate normally.

The mode that the outer rotor 40 drives the wheel blade 20 is described in reference to the first and second embodiments as shown in FIGS. 1 and 2:

In the sectional schematic view of FIG. 1 showing the structure of the first preferred embodiment, the rotating disk 41 of the outer rotor 40 and the annular ferrite magnet 50 with grain alignment on its inner periphery are provided in the water sucking area 11 of the housing 10, a rotating axle 42 is provided at the center of the rotating disk 41, so that the rotating disk 41 and the annular ferrite magnet 50 can be rotated in the water sucking area 11; and the wheel blade 20 is provided on the rotating disk 41, hence the outer rotor 40 and the wheel blade 20 are driven to rotate when the stator 30 in the isolation area 14 when alternate changing of magnetic poles are created by leading in electric power, thereby the function of drawing and delivering fluid stated above can be effected.

In this embodiment, the outer rotor 40 and the annular ferrite magnet 50 with grain alignment on its inner periphery are provided in the water sucking area 11 contacting with the fluid; by virtue that the annular ferrite magnet 50 is divided into the magnetic inner layer 51 and the magnetic conductive outer layer 52, the magnet 50 needs not to have therearound magnetic conductive metal for forming magnetic loops; i.e., the rotating disk 41 does not need to be made of metallic magnetic conductive material. Therefore in practicing, the wheel blade 20 can be provided directly on the rotating disk 41, even the wheel blade 20 and the rotating disk 41 can be injection formed integrally of plastic, this not only can lower the cost of assembling, but also will have no problems of rendering easy oxidation of the metallic magnetic conductive material to result rusting and corrosion when they have to be used in drawing and delivering specific fluid. And the annular ferrite magnet 50 with grain alignment on its inner periphery has the superior features in the wider range of temperature, humidity durability and alkali resistance; the embodiment can have a broader range of application.

In the sectional schematic view of FIG. 2 showing the structure of the second preferred embodiment, the rotating disk 41 of the outer rotor 40 and the annular ferrite magnet 50 with grain alignment on its inner periphery are provided on the housing 10 and in the isolation area 14 separated from the water sucking area 11; the rotating axle 42 is rotated synchronically with the rotating disk 41, the tailing end of the rotating axle 42 is extended out of the isolation area 14 into the water sucking area 11 to fix together with the wheel blade 20 at the center of the latter. When electric power enters the stator 30 to make the magnetic poles change alternately, the outer rotor 40 is driven to rotate and the rotating axle 42 is rotated synchronically therewith; the rotating axle 42 is extended out of the isolation area 14 to fix together with the wheel blade 20, therefore, by transmitting of the rotating axle 42, the wheel blade 20 in the water sucking area 11 is rotated synchronically therewith to draw and deliver fluid.

The principle of this second embodiment is same as that of the first embodiment in using the magnetic coupling mode for transmitting, the difference of it from the first embodiment is: the rotating disk 41 of the outer rotor 40 and the annular ferrite magnet with grain alignment on its inner periphery in this embodiment do not contact with the fluid, and the annular ferrite magnet 50 with grain alignment on its inner periphery is not isolated from the stator 30 by the housing 10 (but appropriate distance shall be kept), so that the effect of magnetic coupling is better.

The names of the elements composing the present invention are only for illustrating a preferred embodiment of the present invention, and not for giving any limitation to the scope of the present invention. It will be apparent to those skilled in this art that various equivalent modifications or changes without departing from the spirit of this invention shall fall within the scope of the appended claims and are intended to form part of this invention.

1. A pump rotated by an outer rotor and having an annular ferrite magnet with grain alignment on its inner periphery, said pump comprises: a housing, a wheel blade, a stator and an outer rotor surrounding said stator, wherein said wheel blade is provided in a water sucking area of said housing having a water inlet and an water outlet and is rotated synchronically with said outer rotor, said stator is isolated from said water sucking area, when electric power enters said stator to make magnetic poles change alternately, said outer rotor is driven by the function of magnetic coupling to synchronically rotate said wheel blade, said pump is characterized in that: said outer rotor is composed of a rotating disk and an annular ferrite magnet with grain alignment on its inner periphery and being fixed on an inner periphery of said rotating disk, said annular ferrite magnet with grain alignment on its inner periphery is a multipolar anisotropic permanent magnet, a main body of said annular ferrite magnet is divided into a magnetic conductive outer layer which is not magnetic and a magnetic inner layer, in order that magnetic fluxes of said magnetic inner layer turn back right away when they pass said magnetic conductive outer layer to thereby shorten magnetic loops, and to increase magnetic force and effect of magnetic energy accumulation.

2. The pump rotated by an outer rotor and having an annular ferrite magnet with grain alignment on its inner periphery as in claim 1, wherein:
said stator is composed of a set of yoke and an induction coil, thereby electric power led into said induction coil in an electronic phase changing mode renders said stator to create alternate changing of magnetic poles.

3. The pump rotated by an outer rotor and having an annular ferrite magnet with grain alignment on its inner periphery as in claim 1, wherein: said rotating disk of said outer rotor and said annular ferrite magnet with grain alignment on its inner periphery are on said housing and in an isolation area; a rotating axle is provided at the center of said rotating disk, thus said rotating disk and said annular ferrite magnet with grain alignment on its inner periphery are adapted to rotating in said water sucking area.

4. The pump rotated by an outer rotor and having an annular ferrite magnet with grain alignment on its inner periphery as in claim 3, wherein: said wheel blade is provided in said rotating disk.

5. The pump rotated by an outer rotor and having an annular ferrite magnet with grain alignment on its inner periphery as in claim 3, wherein: said wheel blade and said rotating disk are injection formed integrally of plastic.

6. The pump rotated by an outer rotor and having an annular ferrite magnet with grain alignment on its inner periphery as in claim 1, wherein: said housing is provided with an isolation area for mounting said stator to be separated from said water sucking area.

7. The pump rotated by an outer rotor and having an annular ferrite magnet with grain alignment on its inner periphery as in claim 6, wherein: said rotating disk of said outer rotor and said annular ferrite magnet with grain alignment on its inner periphery are provided in said isolation area; a rotating axle is provided at the center of said rotating disk rotated synchronically with said rotating disk, an end of said rotating axle is extended out of said isolation area and is extended into said water sucking area to fix together with said wheel blade at the center of the latter.
